(19) United States
(12) Patent Application Publication
(10) Pub. No.: US 2018/0253669 A1
(43) Pub. Date: Sep. 6, 2018

(54) METHOD AND SYSTEM FOR CREATING DYNAMIC CANONICAL DATA MODEL TO UNIFY DATA FROM HETEROGENEOUS SOURCES

(71) Applicant: Wipro Limited, Bangalore (IN)

(72) Inventors: Shyam Sunder Thunoli, Kannur (IN); Rahul Krishna Deshpande, Bangalore (IN); Rohit Sardeshpande, Bangalore (IN); Harshad Subhash Borgaonkar, Mumbai (IN)

(21) Appl. No.: 15/463,628

(22) Filed: Mar. 20, 2017

(30) Foreign Application Priority Data
Mar. 3, 2017 (IN) 201741007500

(51) Int. Cl. G06Q 10/06; G06N 99/00

(52) U.S. Cl. CPC G06Q 10/067; G06N 99/005

(57) ABSTRACT

This disclosure relates to a method and system for creating a dynamic canonical data model. The method includes creating staging tables to analyze regulatory data collected from a plurality of heterogeneous sources. The method further includes creating a dynamic canonical ontology based on the staging tables representing the regulatory data. The dynamic canonical ontology determines a plurality of attributes associated with the regulatory data and relationships amongst the plurality of attributes. The method includes identifying automatically at least one modification associated with at least one of the plurality of attributes by applying machine learning techniques on the staging tables. The method further includes updating the dynamic canonical ontology by adding the at least one modification to create the dynamic canonical data model.

This application claims the benefit of Indian Patent Application Serial No. 201741007500, filed Mar. 3, 2017, which is hereby incorporated by reference in its entirety.

### FIELD

This disclosure relates generally to managing operational tasks in an enterprise network and more particularly to method and system for creating dynamic canonical data model to unify data from heterogeneous sources.

### BACKGROUND

Currently, there are many enterprise wide solutions available to combat enterprise regulatory needs. However, such solutions and products only address few specific issues or areas, for example, pharma and Anti-Money laundering (AML). Most of these solutions work in silos and do not provide a holistic one stop solution for enterprise regulatory requirements. Moreover, the analytics that are utilized by these solutions restrict themselves to mere reporting or dash boarding, which limits the scope of data exploration and deeper analytics. This increases the chances of missing out on critical hidden patterns and information that go beyond defined business rules.

Additionally, enterprise wide data sourcing, transformation, and storage are very complicated, expensive, and restrictive to changes at times. Most of the existing data sourcing techniques follow age old legacy formats and are unable to accommodate newer data channels or data sources, for example, streaming data. Moreover, data ingestion, right from data extraction and mapping to transformations are too complex to design and maintain. It is also expensive for organizations to invest and maintain a monolithic design/architectures or infrastructures/platforms. Organizations find it difficult to maintain optimal balance between cost, scalability, reliability, robustness, availability, ease of use, maintenance, and performance. Choice of software applications and licenses coupled with infrastructure compatibility further make it a tough decision for organizations.

Few conventional systems do perform regulatory reconciliation across the enterprise, but fall-short of holistic view at times in the area of automation, standardization, and traceability. Moreover, these systems are expensive to implement.

### SUMMARY

In one embodiment, a method for creating a dynamic canonical data model is disclosed. The method includes creating, by a data model creating device, staging tables to analyze regulatory data collected from a plurality of heterogeneous sources; creating, by the data model creating device, a dynamic canonical ontology based on the staging tables representing the regulatory data, wherein the dynamic canonical ontology determines a plurality of attributes associated with the regulatory data and relationships amongst the plurality of attributes; identifying automatically, by the data model creating device, at least one modification associated with at least one of the plurality of attributes by applying machine learning techniques on the staging tables; and updating, by the data model creating device, the dynamic canonical ontology by adding the at least one modification to create the dynamic canonical data model.

In another embodiment, a system for creating a dynamic canonical data model is disclosed. The system includes a processor; and a memory communicatively coupled to the processor, wherein the memory stores processor instructions, which, on execution, causes the processor to create staging tables to analyze regulatory data collected from a plurality of heterogeneous sources; create a dynamic canonical ontology based on the staging tables representing the regulatory data, wherein the dynamic canonical ontology determines a plurality of attributes associated with the regulatory data and relationships amongst the plurality of attributes; identify automatically at least one modification associated with at least one of the plurality of attributes by applying machine learning techniques on the staging tables; and update the dynamic canonical ontology by adding the at least one modification to create the dynamic canonical data model.

In yet another embodiment, a non-transitory computer-readable storage medium is disclosed. The non-transitory computer-readable storage medium has instructions stored thereon, a set of computer-executable instructions causing a computer comprising one or more processors to perform steps comprising creating, by a data model creating device, staging tables to analyze regulatory data collected from a plurality of heterogeneous sources; creating, by the data model creating device, a dynamic canonical ontology based on the staging tables representing the regulatory data, wherein the dynamic canonical ontology determines a plurality of attributes associated with the regulatory data and relationships amongst the plurality of attributes; identifying automatically, by the data model creating device, at least one modification associated with at least one of the plurality of attributes by applying machine learning techniques on the staging tables; and updating, by the data model creating device, the dynamic canonical ontology by adding the at least one modification to create the dynamic canonical data model.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a system for creating a canonical data model, in accordance with an embodiment.

FIG. 2 is a block diagram illustrating various modules in a memory of a data model creating device configured to create a canonical data model in an enterprise network, in accordance with an embodiment.

FIG. 3 illustrates a flowchart of a method for creating a dynamic canonical data model in an enterprise network, in accordance with an embodiment.

FIG. 4 illustrates a flowchart of a method for creating a dynamic canonical data model in an enterprise network, in accordance with another embodiment.

FIG. 5 illustrates a block diagram of an exemplary computer system for implementing various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

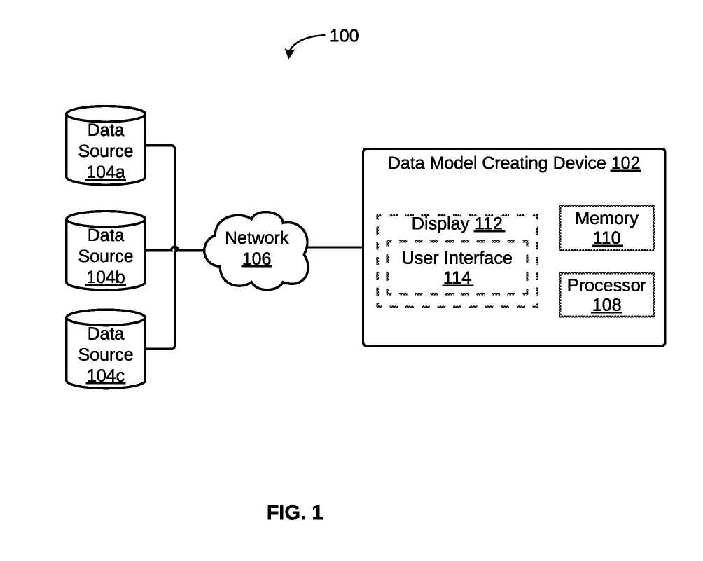

Additional illustrative embodiments are listed below. In one embodiment, a system 100 for creating a canonical data model is illustrated in FIG. 1. System 100 includes a data model creating device 102 that collects regulatory data from a plurality of heterogeneous data sources 104 (for example, a data source 104a, a data source 104b, and a data source 104c) via a network 106, which may be a wireless or a wireline network. Data model creating device 102, for example, may be one of, but is not limited to an application server, a laptop, a smart phone, a phablet, a tablet, and a desktop. Examples of plurality of heterogonous data sources 104 may include, but are not limited to government, regulatory and other institutional websites, relational databases that publish regulatory information.

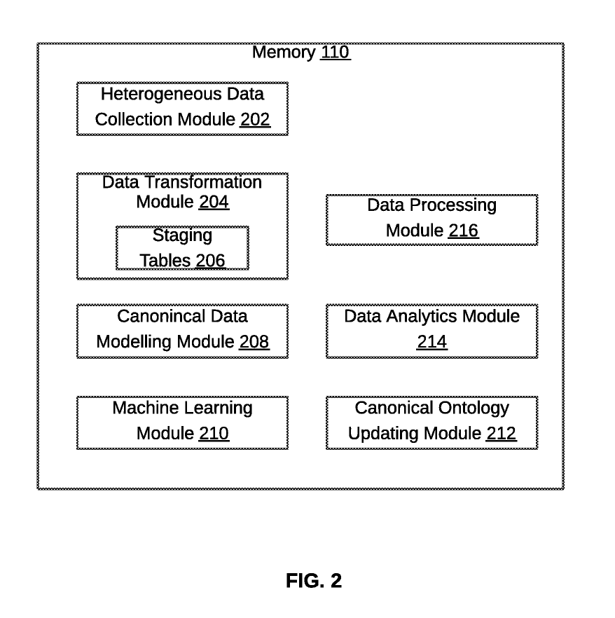

The raw regulatory data collected from plurality of heterogeneous data sources 104 is in different formats and standards, thus, data model creating device 102 first transform the raw regulatory data into a common format that is independent of the type of raw regulatory data being collected. Thereafter, data model creating device 102 processes the regulatory data to create a dynamic canonical data model. To this end, data model creating device 102 includes a processor 108 that is communicatively coupled to a memory 110. Memory 110 further includes various modules that function as a regulatory integration framework and enable data model creating device 102 to create the dynamic canonical data model that collects and unifies data from heterogeneous regulatory data sources in order to identify and interpret the regulatory rules and ensure compliance with these rules. This is explained in detail in conjunction with FIGS. 2, 3, and 4. Data model creating device 102 may further include a display 112 having a User Interface (UI) 114 that may be used by a user to provide inputs and to interact with data model creating device 102. Display 112 may further be used to display reports and result of various analysis performed while creating the dynamic canonical data model.

Referring now to FIG. 2, a block diagram of various modules stored in memory 110 of data model creating device 102 configured to create a dynamic canonical data model is illustrated, in accordance with an embodiment. A heterogeneous data collection module 202 in memory 110 collects regulatory data from a plurality of heterogeneous data sources for further processing. The plurality of heterogeneous data sources may be plurality of heterogeneous data sources 104 as disclosed in FIG. 1. The plurality of heterogeneous data sources may include, but are not limited to government, regulatory and other institutional websites, or relational databases that publish regulatory information. The regulatory data may be extracted in different formats and via different channel and the examples may include, but are not limited to flat files (for example, CSV or txt), real time streaming data (for example, websites, messages, or online chat scripts), relational data sources, or various formats of distributed file system. The regulatory data may include details regarding one or more of a regulatory article, regulatory agency, regulatory rule-making, regulation changes, regulation issuance, regulatory news, and regulatory opinions.

After heterogeneous data collection module 202 extracts the regulatory data in its raw form, a data transformation module 204 loads it into a set of Operation Data Source (ODS) tables that act as temporary tables. Data transformation module 204 then converts the stored regulatory data into a standardized format that is independent of the format and channel associated with the incoming regulatory data. The standardized format may be selected from multiple formats, for example, CSV or txt.

Thereafter, data transformation module 204 creates staging tables 206 to analyze the regulatory data collected from the plurality of heterogeneous data sources. Data transformation module 204 may decide the design specifications of staging tables 206 based on one or more of, but not limited to storage needs (for example, historical, latest, frequency, or latency), storage types (for example, columnar-relational or file system), query processing needs (for example, batch wise or row wise), and storage volumes or types.

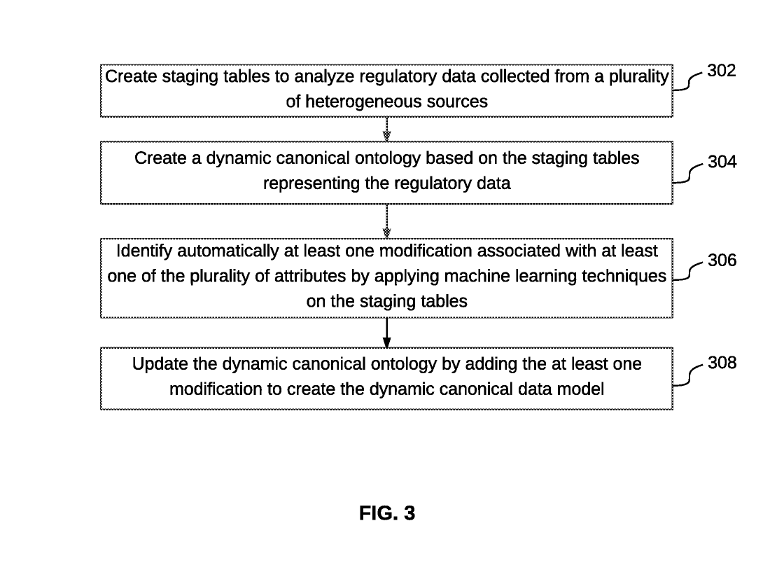

While storing the regulatory data, data transformation module 204 also stores metadata associated with the regulatory data in staging tables 206. Machine learning techniques and network graph analytics may be used to analyze the regulatory data stored in staging tables 206 in order to investigate the regulatory data. As a result of the analysis, attributes (properties or characteristics) of the regulatory data may be learnt. This is further explained in detail in conjunction with flowchart of FIG. 3.

Thereafter, a canonical data modelling module 208, based on staging tables 206, creates a dynamic canonical ontology, which represents the enterprise wide metadata. The dynamic canonical ontology determines a plurality of attributes associated with the regulatory data and relationships amongst these plurality of attributes. The dynamic canonical ontology also defines the lexical and semantical variation in the regulatory data collected from the plurality of heterogeneous data sources. The dynamic canonical ontology is further explained in detail in conjunction with FIG. 3.

Using the dynamic canonical ontology, a machine learning module 210 automatically identifies one or more modifications associated with one or more of the plurality of attributes, by applying machine learning techniques on staging tables 206. The one or more modifications may include one of a new attribute, a change in an existing attribute, or a new combination of attributes associated with the regulatory data. The machine learning techniques help in trending or learning the plurality of attributes of the regulatory data stored in staging tables 206.

In addition to identifying modifications associated with one or more attributes, machine learning module 210 further applies machine learning techniques on staging tables 206 to identify one or more redundant or obsolete attributes from the plurality of attributes and one or more redundant or obsolete relationships from the relationships amongst the plurality of attributes. These redundancies may be identified based on comparison with historical regulatory data.

In order to identify modifications in the attributes or to identify the above discussed redundancies, machine learning module 210 develops a data quality matrix that helps in fine tuning values that may appear for an attribute. The data quality matrix defines best range of values for an attribute by machine learning the usage statistics of the historical regulatory data or errors that occurred in the historical regulatory data. This is further explained in detail in conjunction with FIG. 3.

Thereafter, a canonical ontology updating module 212 updates the dynamic canonical ontology by adding the one or more modifications to finally create the dynamic canonical data model. Canonical ontology updating module 212 also removes the one or more redundant attributes and the one or more redundant relationships to update the dynamic canonical ontology and thereafter creates the dynamic canonical data model. As a result of updating, the dynamic canonical ontology is adapted or extended according to evolution of the regulatory data collected from the plurality of heterogeneous data sources. Canonical ontology updating module 212 thus dynamically updates the dynamic canonical ontology to adapt to changes in attributes and relationship that occur over time based on nature of the regulatory data that is collected from the plurality of heterogeneous data sources. This is further explained in detail in conjunction with FIG. 3.

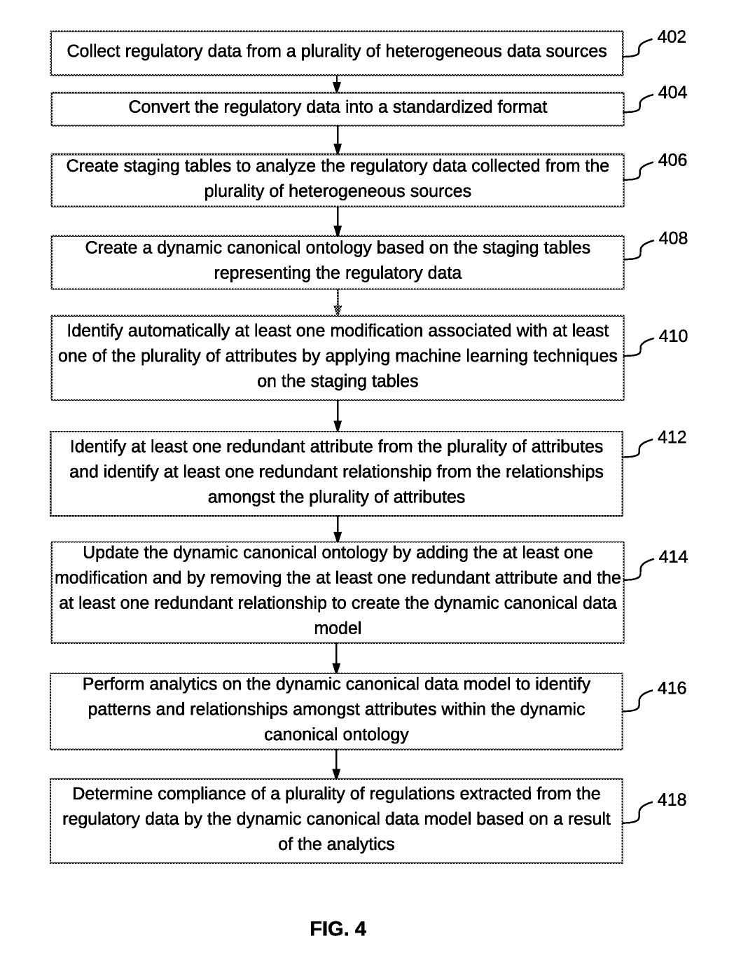

Once the canonical data model has been created, a data analytics module 214 performs analytics on the dynamic canonical data model to identify patterns and relationships amongst attributes within the dynamic canonical ontology, after it has been updated. In other words, patterns and relationships between various attributes and their effect on each other is uncovered. This further helps in performing updates to the dynamical canonical ontology. The analytics performed may include, but are not limited to exploratory analysis and descriptive statistics, such as, mean, median, covariance, correlation coefficient, and standard deviation. Based on a result of the analytics performed on the dynamic canonical data model, a data processing module 216 determines whether a plurality of regulations extracted from the regulatory data by the dynamic canonical data model are complied with or not. This is further explained in detail in conjunction with FIG. 4.

Referring now to FIG. 3, a flowchart of a method for creating a dynamic canonical data model is illustrated, in accordance with an embodiment. To this end, data model creating device 102 collects regulatory data from a plurality of heterogeneous data sources for further processing. The plurality of heterogeneous data sources may include, but are not limited to government, regulatory and other institutional websites, or relational databases that publish regulatory information. The regulatory data may be extracted in different formats and via different channel and the examples may include, but are not limited to flat files (for example, CSV or txt), real time streaming data (for example, websites, messages, or online chat scripts), relational data sources, or various formats of distributed file system. The regulatory data may include details regarding one or more of a regulatory article, regulatory agency, regulatory rule-making, regulation changes, regulation issuance, regulatory news, and regulatory opinions.

After extracting the regulatory data in its raw form, data model creating device 102 loads it into a set of ODS tables that act as temporary tables. In an embodiment, one ODS table may be created for each type of regulatory data source. Data model creating device 102 then converts the stored regulatory data into a standardized format that is independent of the format and channel associated with the incoming regulatory data.

Thereafter, at 302, data model creating device 102 creates staging tables to analyze the regulatory data collected from the plurality of heterogeneous sources. The design specifications of the staging tables may be decided based on one or more of, but is not limited to storage needs (for example, historical, latest, frequency, or latency), storage types (for example, columnar-relational or file system), query processing needs (for example, batch wise or row wise), and storage volumes or types.

While storing the regulatory data, metadata associated with the regulatory data is also stored in the staging tables. Machine learning techniques and network graph analytics may be used to analyze the regulatory data stored in the staging tables in order to investigate the regulatory data. To this end, lineage of the regulatory data may be determined using any existing lineage determining tool. Further, quality matrix for the regulatory data may be generated using automated data quality dashboards. The quality matrix may then be used to iteratively audit the collected regulatory data in order to clean the regulatory data and ensure that the regulatory data is detailed enough to create the canonical data model. Thus, the staging tables are created as part of data discovery, data preparation, and canonical data model planning phases. As a result of this analysis, attributes (properties or characteristics) of the regulatory data may be learnt. This is further explained in detail below.

Based on the staging tables, data model creating device 102 creates a dynamic canonical ontology at 304, which represents the enterprise wide metadata. The dynamic canonical ontology determines a plurality of attributes associated with the regulatory data and relationships amongst these plurality of attributes. The dynamic canonical ontology also defines the lexical and semantical variation in the regulatory data collected from the plurality of heterogeneous data sources. As the dynamic canonical ontology is metadata driven, it helps in modeling the regulatory data and in understanding new regulations and its far reach in already existing regulatory data.

Using the dynamical canonical ontology, data model creating device 102 automatically identifies one or more modifications associated with one or more of the plurality of attributes, at 306, by applying machine learning techniques and network graph analytics on the staging tables. The one or more modifications may include one of a new attribute, a change in an existing attribute, or a new combination of attributes associated with the regulatory data. The machine learning techniques help in trending or learning the plurality of attributes of the regulatory data stored in the staging tables. By way of an example, initial training regulatory data may include relationship map table that maps relationship of a specific value to a particular attribute of the training regulatory data. When data model creating device 102 detects patterns or features of values in the dynamic canonical ontology that do not match to any existing attributes in the relationship map table, data model creating device 102 identifies or recognizes these patterns or features as new attributes of the regulatory data, which is continuously evolving.

In addition to identifying modifications associated with one or more attributes, data model creating device 102 further applies machine learning techniques on the staging tables to identify one or more redundant or obsolete attributes from the plurality of attributes and one or more redundant or obsolete relationships from the relationships amongst the plurality of attributes. These redundancies may be identified based on comparison with the historical regulatory data previously stored by data model creating device 102.

In order to identify modifications in the attributes or to identify the above discussed redundancies, data model creating device 102 develops a data quality matrix that helps in fine tuning values that may appear for an attribute. The data quality matrix defines best range of values for an attribute by machine learning the usage statistics of the historical regulatory data or errors that occurred in the historical regulatory data. By way of an example, data model creating device 102, through machine learning, may find that users regularly access a particular type of regulatory data, which is generated by tweaking the existing regulatory data. Thus, data model creating device 102 identifies such regulatory data to be included in the dynamic canonical ontology, in the form of metadata.

By way of another example, if data model creating device 102 detects that a portion of the regulatory data collected mostly leads to errors because of a problem in values received from a heterogeneous data source for that portion, data model creating device 102 may define the dynamic canonical ontology, such that, it accepts only those values that fall within a particular range according to a situation defined in the data quality matrix.

Thereafter, at 308, data model creating device 102 updates the dynamic canonical ontology by adding the one or more modifications to create the dynamic canonical data model. Data model creating device 102 also removes the one or more redundant attributes and the one or more redundant relationships to update the dynamic canonical ontology and thereafter create the dynamic canonical data model. As a result of updating, the dynamic canonical ontology is adapted or extended according to evolution of the regulatory data collected from the plurality of heterogeneous data sources. In an embodiment, the dynamic canonical ontology is updated only after getting a confirmation from a user. The dynamic canonical ontology is thus dynamically updated to adapt to changes in attributes and relationship that occur over time based on nature of the regulatory data that is collected from the plurality of heterogeneous data sources.

In addition to automatically updating the dynamic canonical ontology by data model creating device 102, a user may also add new attributes of an application that may not be currently relevant, but may become relevant in future for the application. An application, for example, may include AML or Pharma. This makes the dynamic canonical ontology more comprehensive and helps in understanding upcoming regulatory data in future. The user can thus extend parameter boundaries for attributes associated with various applications, considering dynamic changes in these application (or customer) environment. In other words, there is no rules boundary under which the dynamic canonical data model is created for regulatory compliance.

In an embodiment, dynamic canonical data models are designed and built specifically for target business systems or applications. The dynamic canonical data models enable integration of various enterprise applications and also standardizes agreed data definitions associated with integrating of these enterprise applications. This further helps in reduction of costs. By way of an example, an AML data model may be created to integrate data needs of various enterprise applications that may include, but are not limited to Actimize, Oracle Mantas, SAS AML, or Teradata AML. Once the canonical data model has been created, data model creating device 102 performs analytics on the dynamic canonical data model to identify patterns and relationships amongst attributes within the dynamic canonical ontology, after it has been updated. This is further explained in detail in conjunction with FIG. 4.

Referring now to FIG. 4, a flowchart of a method for creating a canonical data model is illustrated, in accordance with another embodiment. At 402, data model creating device 102 collects regulatory data from a plurality of heterogeneous data sources. At 404, data model creating device 102 converts the regulatory data into a standardized format. At 406, data model creating device 102 creates staging tables to analyze the regulatory data collected from the plurality of heterogeneous sources. At 408, data model creating device 102 creates a dynamic canonical ontology based on the staging tables representing the regulatory data. Thereafter, at 410, data model creating device 102 automatically identifies one or more modifications associated with one or more of the plurality of attributes by applying machine learning techniques on the staging tables. This has been explained in detail in conjunction with FIG. 3.

At 412, data model creating device 102 identifies one or more redundant attributes from the plurality of attributes and one or more redundant relationships from the relationships amongst the plurality of attributes. At 414, data model creating device 102 updates the dynamic canonical ontology by adding the one or more modification and by removing the one or more redundant attributes and the one or more redundant relationships to create the dynamic canonical data model. This has been explained in detail in conjunction with FIG. 3.

Once the dynamic canonical data model has been created, data model creating device 102, at 416, performs analytics on the dynamic canonical data model to identify patterns and relationships amongst attributes within the dynamic canonical ontology after it has been updated. In other words, patterns and relationships between various attributes and their effect on each other is uncovered. This further helps in performing updates to the dynamical canonical ontology. The analytics performed may include exploratory analysis that include custom dashboards as part of data preparation for use-cases, for example, finding dirty or missing data using scatterplot, scatterplot matrix, histogram and multi-variable analysis using Box-and-Whisker plot, or Hexbin plot. The analytics performed may also include descriptive statistics, such as, mean, median, covariance, correlation coefficient, and standard deviation, performed using pre-built automated dashboards.

Based on a result of the analytics performed on the dynamic canonical data model, data model creating device 102, at 418, determines whether a plurality of regulations extracted from the regulatory data by the dynamic canonical data model are complied with or not. In other words, the result of the analytics is used to determine whether a plurality of rules and regulations identified and interpreted from the regulatory data collected are complied with or not.

Thus, a platform based regulatory integration gateway and framework is provided that generates dynamic canonical data models, which help in addressing data management activities that are difficult to execute and manage. Examples of such data management activities may include, but are not limited to data quality, reconciliation, lineage, and knowing regulatory oversight posed by regulations (for example, BCBS239). Different types of dynamic canonical data models are created based on the type of the application in which the entire system needs to be deployed. The regulatory integration gateway is built on tightly integrated foundations from four fields of study, which include namely Cloud, Big data, Data science, and DevOps. As the regulatory integration gateway is built on Cloud services, it is globally accessible, scalable, secure, and cost effective. The regulatory integration gateway architecture is designed in such a way that any component or technology is easily replaceable making it de-coupling efficient. As a result, existing customer technology stacks can be easily integrated with the above provided solution. The regulatory integration gateway utilizes advanced analytical techniques to understand and to unearth hidden patterns and truth about the collected regulatory data. Typical use-case of these analytical techniques are in the form of anomaly detection, feature engineering, validation, error-correction, finding missing regulatory data, and filling up for missing regulatory data.

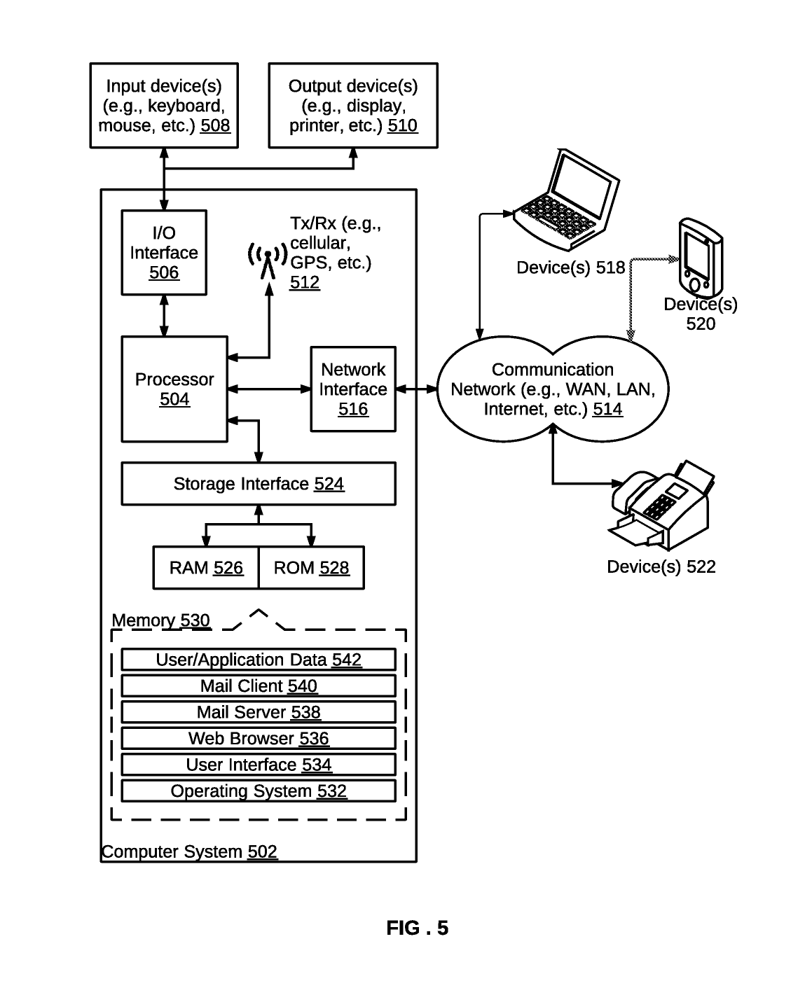

FIG. 5 is a block diagram of an exemplary computer system for implementing various embodiments. Computer system 502 may comprise a central processing unit (“CPU” or “processor”) 504. Processor 504 may comprise at least one data processor for executing program components for executing user- or system-generated requests. A user may include a person, a person using a device such as such as those included in this disclosure, or such a device itself. Processor 504 may include specialized processing units such as integrated system (bus) controllers, memory management control units, floating point units, graphics processing units, digital signal processing units, etc. The processor may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 504 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 504 may be disposed in communication with one or more input/output (I/O) devices via an I/O interface 506. I/O interface 506 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 506, computer system 502 may communicate with one or more I/O devices. For example, an input device 508 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 510 may be a printer, fax machine, video display (e.g., cathode ray tube (CRT), liquid crystal display (LCD), light-emitting diode (LED), plasma, or the like), audio speaker, etc. In some embodiments, a transceiver 512 may be disposed in connection with processor 504. Transceiver 512 may facilitate various types of wireless transmission or reception. For example, transceiver 512 may include an antenna operatively connected to a transceiver chip (e.g., TEXAS® INSTRUMENTS WILINK WL1283® transceiver, BROADCOM® BCM4550IUB8® transceiver, INFINEON TECHNOLOGIES® X-GOLD 618-PMB9800® transceiver, or the like), providing IEEE 802.11a/b/g/n, Bluetooth, FM, global positioning system (GPS), 2G/3G HSDPA/HSUPA communications, etc.

In some embodiments, processor 504 may be disposed in communication with a communication network 514 via a network interface 516. Network interface 516 may communicate with communication network 514. Network interface 516 may employ connection protocols including, without limitation, direct connect, Ethernet (e.g., twisted pair 50/500/5000 Base T), transmission control protocol/internet protocol (TCP/IP), token ring, IEEE 802.11a/b/g/n/x, etc. Communication network 514 may include, without limitation, a direct interconnection, local area network (LAN), wide area network (WAN), wireless network (e.g., using Wireless Application Protocol), the Internet, etc. Using network interface 516 and communication network 514, computer system 502 may communicate with devices 518, 520, and 522. These devices may include, without limitation, personal computer(s), server(s), fax machines, printers, scanners, various mobile devices such as cellular telephones, smartphones (e.g., APPLE® IPHONE® smartphone, BLACKBERRY® smartphone, ANDROID® based phones, etc.), tablet computers, eBook readers (AMAZON® KINDLE® ereader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, computer system 502 may itself embody one or more of these devices.

In some embodiments, processor 504 may be disposed in communication with one or more memory devices (e.g., RAM 526, ROM 528, etc.) via a storage interface 524. Storage interface 524 may connect to memory 530 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 530 may store a collection of program or database components, including, without limitation, an operating system 532, user interface application 534, web browser 536, mail server 538, mail client 540, user/application data 542 (e.g., any data variables or data records discussed in this disclosure), etc. The operating system 532 may facilitate resource management and operation of the computer system 502. Examples of operating systems 532 include, without limitation, APPLE® MACINTOSH® OS X platform, UNIX platform, Unix-like system distributions (e.g., Berkeley Software Distribution (BSD), FreeBSD, NetBSD, OpenBSD, etc.), LINUX distributions (e.g., RED HAT®, UBUNTU®, KUBUNTU®, etc.), IBM® OS/2 platform, MICROSOFT® WINDOWS® platform (XP, Vista/7/8, etc.), APPLE® IOS® platform, GOOGLE® ANDROID® platform, BLACKBERRY® OS platform, or the like. User interface 534 may facilitate display, execution, interaction, manipulation, or operation of program components through textual or graphical facilities. For example, user interfaces may provide computer interaction interface elements on a display system operatively connected to the computer system 502, such as cursors, icons, check boxes, menus, scrollers, windows, widgets, etc. Graphical user interfaces (GUis) may be employed, including, without limitation, Apple® Macintosh® operating systems' AQUA® platform, IBM® OS/2® platform, MICROSOFT® WINDOWS® platform (e.g., AERO® platform, METRO® platform, etc.), UNIX X-WINDOWS, web interface libraries (e.g., ACTIVEX® platform, JAVA® programming language, JAVASCRIPT® programming language, AJAX® programming language, HTML, ADOBE® FLASH® platform, etc.), or the like.

In some embodiments, the computer system 502 may implement a web browser 536 stored program component. The web browser 536 may be a hypertext viewing application, such as MICROSOFT® INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVA® programming language, application programming interfaces (APis), etc. In some embodiments, the computer system 502 may implement a mail server 538 stored program component. The mail server may be an Internet mail server such as MICROSOFT® EXCHANGE® mail server, or the like. The mail server 538 may utilize facilities such as ASP, ActiveX, ANSI C++/C#, MICROSOFT .NET® programming language, CGI scripts, JAVA® programming language, JAVASCRIPT® programming language, PERL® programming language, PHP® programming language, PYTHON® programming language, WebObjects, etc. The mail server 538 may utilize communication protocols such as internet message access protocol (IMAP), messaging application programming interface (MAPI), Microsoft Exchange, post office protocol (POP), simple mail transfer protocol (SMTP), or the like. In some embodiments, the computer system 502 may implement a mail client 540 stored program component. The mail client 540 may be a mail viewing application, such as APPLE MAIL® mail client, MICROSOFT ENTOURAGE® mail client, MICROSOFT OUTLOOK® mail client, MOZILLA THUNDERBIRD® mail client, etc.

In some embodiments, computer system 502 may store user/application data 542, such as the data, variables, records, etc. as described in this disclosure. Such databases may be implemented as fault-tolerant, relational, scalable, secure databases such as ORACLE® database OR SYBASE® database.

Alternatively, such databases may be implemented using standardized data structures, such as an array, hash, linked list, struct, structured text file (e.g., XML), table, or as object-oriented databases (e.g., using OBJECTSTORE® object database, POET® object database, ZOPE® object database, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Various embodiments provide method and system for creating dynamic canonical data model to unify data from heterogeneous sources. In this method, a dynamic canonical ontology (or an enterprise wide metadata) is first created and updated based on machine learning techniques applied on regulatory data collected from heterogeneous data sources. The dynamic canonical ontology is then used to create dynamic canonical data models based on an end application. These dynamic canonical data models easily and efficiently address data management activities that are difficult to execute and manage. Examples of these data management activities include, but are not limited to quality of regulatory data, reconciliation, lineage, and knowing the regulatory oversight posed by regulations. These dynamic canonical data models also facilitate integrated data governance and data management that may include activities like data discovery, profiling, data dictionary, taxonomies, business glossaries, audits, data lineage, metadata policy management, integrated backups and disaster recovery.

The specification has described method and system for creating dynamic canonical data model to unify data from heterogeneous sources. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for creating a dynamic canonical data model, the method comprising:
creating, by a data model creating device, staging tables to analyze regulatory data collected from a plurality of heterogeneous sources;
creating, by the data model creating device, a dynamic canonical ontology based on the staging tables representing the regulatory data, wherein the dynamic canonical ontology determines a plurality of attributes associated with the regulatory data and relationships amongst the plurality of attributes;
identifying automatically, by the data model creating device, at least one modification associated with at least one of the plurality of attributes by applying machine learning techniques on the staging tables; and
updating, by the data model creating device, the dynamic canonical ontology by adding the at least one modification to create the dynamic canonical data model.

2. The method of claim 1 further comprising collecting the regulatory data from the plurality of heterogeneous data sources.

3. The method of claim 2 further comprising converting the regulatory data into a standardized format for the dynamic canonical model.

4. The method of claim 1, wherein the regulatory data is analyzed to determine a data lineage and at least one quality matrix associated with the regulatory data.

5. The method of claim 1, wherein the dynamic canonical ontology defines lexical and semantical variations in the regulatory data.

6. The method of claim 1 further comprising:
identifying at least one redundant attribute from the plurality of attributes by applying the machine learning techniques on the staging tables; and
identifying at least one redundant relationship from the relationships amongst the plurality of attributes by applying the machine learning techniques on the staging tables.

7. The method of claim 6, wherein updating the dynamic canonical ontology comprises removing the at least one redundant attribute and the at least one redundant relationship from the dynamic canonical ontology.

8. The method of claim 1, wherein the at least one modification comprises at least one of a new attribute, a change in an existing attribute, or a new combination of attributes.

9. The method of claim 1 further comprising performing analytics on the dynamic canonical data model to identify patterns and relationships amongst attributes within the dynamic canonical ontology after being updated.

10. The method of claim 9 further comprising determining compliance of a plurality of regulations extracted from the regulatory data by the dynamic canonical data model based on a result of the analytics performed on the dynamic canonical data model.

11. A system for creating a dynamic canonical data model, the system comprising:
a processor; and
a memory communicatively coupled to the processor, wherein the memory stores processor instructions, which, on execution, causes the processor to:
create staging tables to analyze regulatory data collected from a plurality of heterogeneous sources;
create a dynamic canonical ontology based on the staging tables representing the regulatory data, wherein the dynamic canonical ontology determines a plurality of attributes associated with the regulatory data and relationships amongst the plurality of attributes;
identify automatically at least one modification associated with at least one of the plurality of attributes by applying machine learning techniques on the staging tables; and
update the dynamic canonical ontology by adding the at least one modification to create the dynamic canonical data model.

12. The system of claim 11, wherein the processor instructions further cause the processor to collect the regulatory data from the plurality of heterogeneous data sources.

13. The system of claim 11, wherein the regulatory data is analyzed to determine a data lineage and at least one quality matrix associated with the regulatory data.

14. The system of claim 11, wherein the processor instructions further cause the processor to:
identify at least one redundant attribute from the plurality of attributes by applying the machine learning techniques on the staging tables; and
identify at least one redundant relationship from the relationships amongst the plurality of attributes by applying the machine learning techniques on the staging tables.

15. The system of claim 14, wherein to update the dynamic canonical ontology the processor instructions further cause the processor to remove the at least one redundant attribute and the at least one redundant relationship from the dynamic canonical ontology.

16. The system of claim 11, wherein the at least one modification comprises at least one of a new attribute, a change in an existing attribute, or a new combination of attributes.

17. The system of claim 11, wherein the processor instructions further cause the processor to perform analytics on the dynamic canonical data model to identify patterns and relationships amongst attributes within the dynamic canonical ontology after being updated.

18. The system of claim 17, wherein the processor instructions further cause the processor to determine compliance of a plurality of regulations extracted from the regulatory data by the dynamic canonical data model based on a result of the analytics performed on the dynamic canonical data model.

19. A non-transitory computer-readable storage medium having stored thereon, a set of computer-executable instructions causing a computer comprising one or more processors to perform steps comprising:
creating, by a data model creating device, staging tables to analyze regulatory data collected from a plurality of heterogeneous sources;
creating, by the data model creating device, a dynamic canonical ontology based on the staging tables representing the regulatory data, wherein the dynamic canonical ontology determines a plurality of attributes associated with the regulatory data and relationships amongst the plurality of attributes;
identifying automatically, by the data model creating device, at least one modification associated with at least one of the plurality of attributes by applying machine learning techniques on the staging tables; and
updating, by the data model creating device, the dynamic canonical ontology by adding the at least one modification to create the dynamic canonical data model.
